(19) United States
(12) Patent Application Publication
(10) Pub. No.: US 2026/0368704 A1
(43) Pub. Date: Nov. 19, 2026

(54) SYSTEM AND METHOD FOR ROLE-BASED AUTOMATIC ASSOCIATION OF INTERACTIVE CONTROLS WITH CONTENT ITEMS

(71) Applicant: Angelina Geetanjali Dhani Mohamed, Yonkers, NY (US)

(72) Inventor: Angelina Geetanjali Dhani Mohamed, Yonkers, NY (US)

(21) Appl. No.: 19/737,029

(22) Filed: Jul. 10, 2026

(51) Int. Cl. G06Q 10/40

(52) U.S. Cl. CPC G06Q 10/40

(57) ABSTRACT

A system for role-based automatic association of interactive controls with content items on a social-networking platform. The system comprises a computing device having a processor configured to execute a plurality of modules. A user-role management module stores and updates role information associated with user accounts. A content management module manages and distributes content posts. A role-based provisioning module automatically provisions mentorship-booking functionality and automatically generates, associates, synchronizes, updates, and removes interactive booking controls across existing and subsequently generated content posts responsive to stored role information. An availability-management module manages bookable session time slots, and a pricing-management module manages pricing information. A booking and scheduling module manages booking requests and reservations. A payment coordination module coordinates payment authorization and confirmation. A session-delivery module facilitates mentorship sessions. A state-management module maintains synchronized state information and reconciles booking-control associations across content-post records for integrated booking, payment, scheduling, and session delivery.

### FIELD OF INVENTION

The present disclosure relates generally to social networking platforms, content management systems, and computer-implemented user provisioning architectures, and more particularly to a system for automatically attaching interactive booking controls to content posts and supporting integrated scheduling, payment processing, and session delivery within a social networking environment based on stored user-role information.

### BACKGROUND

In recent years, social networking platforms have become widely adopted across personal, professional, educational, and commercial environments. Such platforms enable users to create profiles, publish content, exchange information, participate in communities, and interact with audiences through various forms of digital communication. The widespread availability of mobile computing devices, broadband connectivity, and content-sharing technologies has further increased the volume of user-generated content and online interactions occurring within social networking environments.

As social networking platforms continue to evolve, they are increasingly used as channels for professional networking, knowledge sharing, career development, coaching, consultation, and mentorship-related activities. Users possessing specialized expertise, professional experience, or subject-matter knowledge often publish content intended to educate, inform, or guide other users. Similarly, individuals seeking advice, instruction, or professional guidance utilize such platforms to discover and engage with knowledgeable individuals whose expertise is demonstrated through published content and community participation.

In many existing environments, interactions originating from content consumption and audience engagement extend beyond the capabilities provided by the social networking platform itself. A user who wishes to engage in a structured consultation, coaching interaction, mentorship engagement, or similar session with another user commonly relies upon multiple independent services to complete the interaction lifecycle. Such services may include external scheduling systems, separate payment-processing platforms, calendar-management applications, communication tools, and virtual meeting services.

As a result, existing workflows involve transitions among multiple computing systems during the process of discovering a service provider, evaluating availability, scheduling an appointment, processing payments, coordinating participation, and conducting a remote session. Each transition between such services adds user-interaction friction, requires a creator or provider to assemble and maintain links connecting different services, and fragments the interaction across systems that do not share a common operational state. Consequently, a viewer may have no direct, in-context mechanism for initiating a scheduled and paid session with a creator at the moment of content engagement.

Various social networking platforms, appointment-management services, scheduling applications, mentoring systems, and communication systems have been developed to facilitate portions of these workflows. Certain platforms permit users to publish content, create professional profiles, participate in communities, and establish networking relationships. Third-party scheduling services allow users to define availability, manage appointments, reserve time slots, and coordinate calendar activities. Separate payment-processing platforms facilitate electronic transactions associated with scheduled services, while video-conferencing systems provide communication channels for conducting remote interactions between participants.

Various approaches address portions of this workflow. For example, a prior-art reference, U.S. Pat. No. 11,741,435B1 describes networking-based session-request and scheduling mechanisms initiated from within a networking platform, including selectable indicators associated with provider information. A prior-art reference, AU2016101985A4 describes mentorship-oriented social environments supporting mentor discovery. A prior-art reference, US20250373911 describes networking platforms incorporating mentor directories, social-feed interactions, scheduling, and communication sessions. A prior-art reference, US20250182219A1 describes mentor discovery, matching, and meeting-coordination functionality.

Although such approaches facilitate scheduling, appointment coordination, consultation management, mentoring interactions, communication-event management, or transaction processing, they do not adequately address automatic association of interactive booking controls with a user's own content items based on stored role information of the user account. In existing approaches, where a booking control is present, the control is commonly associated with a profile page, destination page, or tag applied to a media item rather than being automatically associated with all existing and subsequently generated content items of a provider account based on stored account-role information.

Further, existing approaches commonly require user-driven configuration, manual link placement, profile-level booking setup, request-based scheduling, or movement across external scheduling, payment, and communication services. Scheduling may be handled as a request subject to provider approval rather than as reservation of a specific available time slot. Availability information, payment processing, and resulting live-session delivery may be handled through separate stages or independent systems that do not share state, which can leave booking references stale or inconsistent when a user's role, availability, or booking status changes.

Accordingly, despite the availability of social networking platforms, professional networking systems, mentoring environments, appointment-scheduling services, payment-processing infrastructures, and virtual communication platforms, technical challenges continue to exist with respect to reducing workflow fragmentation, minimizing dependence on multiple independent computing environments, maintaining consistent operational state across related platform activities, reducing redundant user interactions, and improving the efficiency with which users transition from content engagement to structured interactive sessions within online platform environments.

Therefore, there remains a need for a system configured to automatically associate an interactive booking control with content items of a user account based on a selected role associated with the user account, without requiring the user to create, configure, link, tag, or place the control. There is also a need for a system that automatically updates the association of the interactive booking control as the selected role changes and resolves availability presentation, slot reservation, payment processing, and live-session delivery natively within the platform, so that discovery, booking, payment, scheduling, and session delivery occur in a single environment with internally consistent state.

### SUMMARY OF THE INVENTION

The following presents a simplified summary of one or more embodiments of the present disclosure to provide a basic understanding of such embodiments. This summary is not an extensive overview of all contemplated embodiments and is intended to neither identify key nor critical elements of all embodiments, nor delineate the scope of any or all embodiments.

The present disclosure, in one or more embodiments, relates to a system for automatically attaching interactive booking controls to content posts and supporting integrated scheduling, payment processing, and session delivery within a social networking environment based on stored user-role information.

An embodiment of a first aspect, the system comprises a computing device having at least one processor and at least one memory storing executable instructions. In one embodiment herein, the computing device is operatively connected to at least one client device and at least one payment-processing system via at least one network.

In one embodiment herein, the processor is configured to execute a plurality of modules to cause the system to perform role-based automatic association of interactive controls with content items on a social-networking platform. In one embodiment herein, the plurality of modules comprises a user-role management module, a content management module, a role-based provisioning module, an availability-management module, a pricing-management module, a booking and scheduling module, a payment coordination module, a session-delivery module, and a state-management module.

In one embodiment herein, the user-role management module is configured to store a selected role associated with a user account. In one embodiment herein, the selected role comprises at least one of a mentor role, a mentee role, and a mentor-and-mentee role. In one embodiment herein, the user-role management module is configured to update the selected role responsive to a role-modification request. In one embodiment herein, the content management module is configured to store a plurality of content posts associated with the user account as respective content-post records. In one embodiment herein, the plurality of content posts comprises existing content posts and subsequently generated content posts. In one embodiment herein, the content management module is configured to distribute the plurality of content posts through a social-networking content feed.

In one embodiment herein, the role-based provisioning module is operatively coupled to the user-role management module and the content management module. In one embodiment herein, the role-based provisioning module is configured to determine, from the stored selected role, whether the user account comprises the mentor role. Responsive to determining that the user account comprises the mentor role, the role-based provisioning module is configured to automatically generate an interactive booking control according to a platform-defined configuration.

In one embodiment herein, the role-based provisioning module is configured to maintain a booking-control association state in a role-association index separate from the content-post records. In one embodiment herein, the booking-control association state comprises a single association record keyed to the user account and logically associating the interactive booking control with the existing content posts and the subsequently generated content posts associated with the user account. In one embodiment herein, the booking-control association state is maintained without requiring user-authored creation, configuration, insertion, linking, tagging, placement, maintenance, booking-link creation, booking-service integration, booking-widget installation, or content-post modification.

In one embodiment herein, the role-based provisioning module is configured to cause the interactive booking control to be presented with a content post among the existing content posts and the subsequently generated content posts by resolving the single association record from the role-association index when the content post is served through the social-networking content feed. In one embodiment herein, presentation of the interactive booking control is performed without performing a per-post write to the content-post records.

In one embodiment herein, responsive to modification of the selected role, the role-based provisioning module is configured to automatically reconcile the booking-control association state through an idempotent update operation such that the interactive booking control is added to or removed from the existing content posts and the subsequently generated content posts associated with the user account. In one embodiment herein, the reconciliation is performed without rewriting each content-post record, thereby reducing write amplification and improving synchronization efficiency in a distributed computing environment.

In one embodiment herein, the availability-management module is configured to manage availability information comprising bookable session time slots. In one embodiment herein, the pricing-management module is configured to manage pricing information associated with the bookable session time slots. In one embodiment herein, the booking and scheduling module is configured to receive a booking request corresponding to a selected session time slot. In one embodiment herein, each bookable session time slot is represented by a slot record having a slot-state field indicating at least one of an available state and a reserved state. In one embodiment herein, the booking and scheduling module is configured to reserve the selected session time slot by executing an atomic compare-and-set operation on the slot-state field conditioned on the slot-state field indicating the available state, such that only one of a plurality of concurrent booking requests transitions the selected session time slot to the reserved state.

In one embodiment herein, the state-management module is configured to maintain synchronized state information among the booking-control association information, availability information, booking information, payment information, scheduling information, and session information associated with a session record. In one embodiment herein, modification of the selected role generates a role-change event published to an event bus, and one or more subscriber processes consume the role-change event and cause the role-based provisioning module to reconcile the booking-control association state asynchronously.

In one embodiment herein, the role-based provisioning module is configured to reconcile the booking-control association state via an atomic update operation conditioned on version information associated with the booking-control association state. In one embodiment herein, the system is configured to invalidate cached served representations associated with content posts of the user account responsive to reconciliation of the booking-control association state. In one embodiment herein, invalidation of the cached served representations causes subsequent content-serving requests to re-resolve the booking-control association state and present an updated interactive booking control state.

In one embodiment herein, the interactive booking control is associated with individual content posts distributed through the social-networking content feed rather than solely with a profile interface associated with the user account. In one embodiment herein, the role-based provisioning module is configured to remove association of the interactive booking control from the existing content posts and prevent association of the interactive booking control with subsequently generated content posts when the selected role no longer comprises the mentor role.

In one embodiment herein, activation of the interactive booking control invokes an application-programming-interface endpoint configured to return availability information and pricing information associated with the user account for presentation within the social-networking platform without redirection to an external scheduling service. In one embodiment herein, the plurality of modules is operatively coupled to automatically generate, associate, render, synchronize, update, and remove interactive booking controls across all existing content posts and all subsequently generated content posts responsive to changes in stored role information without requiring at least one of user-authored creation, configuration, insertion, linking, tagging, placement, maintenance, booking-link creation, booking-service integration, booking-widget installation, and content-post modification.

In one embodiment herein, the booking and scheduling module is further configured to update the availability information responsive to reservation of the selected session time slot, propagate updated availability information to at least one client device accessing the availability information, and generate the session record corresponding to the booking request. In one embodiment herein, the payment coordination module is configured to receive payment authorization information associated with the booking request, coordinate payment authorization and payment confirmation for the selected session time slot through the payment-processing system using a stored payment instrument associated with a viewer account, and generate booking-confirmation information responsive to successful payment confirmation.

In one embodiment herein, the session-delivery module is configured to generate session-access information associated with a scheduled mentorship session, communicate the session-access information to participant accounts through the social-networking platform, and establish and host the scheduled mentorship session through a platform-integrated communication interface without requiring an external video-conferencing service. In one embodiment herein, the state-management module is configured to propagate state updates generated by the booking and scheduling module, the payment coordination module, and the session-delivery module across the plurality of modules.

According to another aspect, the present invention provides the method for role-based automatic association of the interactive controls with the content items on the social-networking platform through the system. At one step, the user-role management module executed by the at least one processor stores the selected role associated with the user account. In one embodiment herein, the selected role comprises at least one of the mentor role, the mentee role, and the mentor-and-mentee role. At a subsequent step, the user-role management module updates the selected role responsive to the role-modification request.

At a next step, the content management module stores the plurality of content posts associated with the user account as the respective content-post records. In one embodiment herein, the plurality of content posts comprises the existing content posts and the subsequently generated content posts. At a subsequent step, the content management module distributes the plurality of content posts through the social-networking content feed.

At a next step, the role-based provisioning module determines whether the selected role comprises the mentor role. At a subsequent step, responsive to determining that the selected role comprises the mentor role, the role-based provisioning module generates the interactive booking control according to the platform-defined configuration.

At a next step, the role-based provisioning module maintains the booking-control association state in the role-association index separate from the content-post records. In one embodiment herein, the booking-control association state comprises the single association record keyed to the user account and logically associating the interactive booking control with the existing content posts and the subsequently generated content posts associated with the user account. In one embodiment herein, the booking-control association state is maintained without requiring user-authored creation, configuration, insertion, linking, tagging, placement, maintenance, booking-link creation, booking-service integration, booking-widget installation, or content-post modification.

At a subsequent step, the role-based provisioning module causes the interactive booking control to be presented with the content post among the existing content posts and the subsequently generated content posts by resolving the single association record from the role-association index when the content post is served through the social-networking content feed. In one embodiment herein, the interactive booking control is presented without performing the per-post write to the content-post records.

At a next step, responsive to modification of the selected role, the role-based provisioning module reconciles the booking-control association state through the idempotent update operation such that the interactive booking control is added to or removed from the existing content posts and the subsequently generated content posts associated with the user account. In one embodiment herein, the reconciliation is performed without rewriting each content-post record, thereby reducing write amplification and improving synchronization efficiency in the distributed computing environment.

At a subsequent step, the system manages the availability information comprising the bookable session time slots and manages the pricing information associated with the bookable session time slots. At a next step, the booking and scheduling module receives the booking request corresponding to the selected session time slot.

At a subsequent step, the booking and scheduling module reserves the selected session time slot by executing the atomic compare-and-set operation on the slot-state field of the slot record representing the selected session time slot. In one embodiment herein, the atomic compare-and-set operation is conditioned on the slot-state field indicating the available state, such that only one of the plurality of concurrent booking requests transitions the selected session time slot to the reserved state.

At a next step, the state-management module maintains the synchronized state information among the booking-control association information, the availability information, the booking information, the payment information, the scheduling information, and the session information associated with the session record. In one embodiment herein, responsive to modification of the selected role, the system publishes the role-change event to the event bus, and the one or more subscriber processes consume the role-change event and cause reconciliation of the booking-control association state asynchronously.

At a subsequent step, the payment coordination module receives the payment authorization information associated with the booking request, coordinates the payment authorization and the payment confirmation through the payment-processing system using the stored payment instrument associated with the viewer account, and generates the booking-confirmation information responsive to successful payment confirmation.

At a next step, the session-delivery module generates the session-access information associated with the scheduled mentorship session, communicates the session-access information to the participant accounts through the social-networking platform, and establishes and hosts the scheduled mentorship session through the platform-integrated communication interface without requiring the external video-conferencing service.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

The accompanying drawings, which are incorporated in and constitute a part of the specification, illustrate an embodiment of the invention, and, together with the description, explain the principles of the invention.

FIG. 1 illustrates a block diagram of a system for role-based automatic association of interactive controls with content items, in accordance with embodiments of the invention.

FIG. 2 illustrates a flow diagram of the system depicting a method for role-based automatic association of interactive controls with content items on a social-networking platform, in accordance with embodiments of the invention.

FIG. 3 illustrates a block diagram of a system architecture for role-based automatic association of interactive controls with content items within the social-networking platform, in accordance with embodiments of the invention.

FIG. 4 illustrates an exemplary user-interface workflow for role-based automatic association of interactive controls with content items within the social-networking platform, in accordance with embodiments of the invention.

FIGS. 5A-5B illustrate a flowchart of a method for role-based automatic booking control attachment and platform-native session delivery on the social networking platform through the system, in accordance with embodiments of the invention.

### DETAILED DESCRIPTION

Reference will now be made in detail to the present preferred embodiments of the invention, examples of which are illustrated in the accompanying drawings. Wherever possible, the same reference numerals are used in the drawings and the description to refer to the same or like parts.

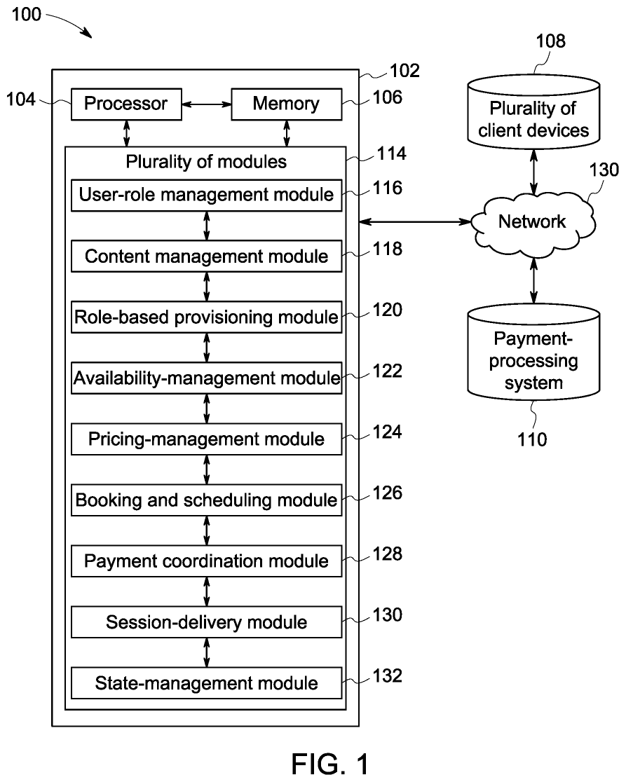

FIG. 1 refers to a block diagram of a system 100 for role-based automatic booking control attachment and platform-native session delivery. In one embodiment herein, the system 100 comprises a computing device 102 having at least one processor 104 and at least one memory 106 storing executable instructions. In one embodiment herein, the computing device 102 is operatively connected to at least one client device 108 and at least one payment-processing system 110 through at least one network 112.

In one embodiment herein, the processor 104 is configured to execute a plurality of modules 114 to cause the system 100 to perform role-based automatic association of interactive controls with content items on a social-networking platform. In one embodiment herein, the plurality of modules 114 comprises a user-role management module 116, a content management module 118, a role-based provisioning module 120, an availability-management module 122, a pricing-management module 124, a booking and scheduling module 126, a payment coordination module 128, a session-delivery module 130, and a state-management module 132.

In one embodiment herein, the user-role management module 116 is configured to store a selected role associated with a user account. In one embodiment herein, the selected role comprises at least one of a mentor role, a mentee role, and a mentor-and-mentee role. In one embodiment herein, the user-role management module 116 is configured to update the selected role responsive to a role-modification request. In one embodiment herein, the user-role management module 116 is configured to present the mentor role, the mentee role, and the mentor-and-mentee role as selectable options during account registration. In one embodiment herein, the selected role remains associated with the user account and is modifiable through account-management operations.

In one embodiment herein, the content management module 118 is configured to store a plurality of content posts associated with the user account as respective content-post records. In one embodiment herein, the plurality of content posts comprises existing content posts and subsequently generated content posts. In one embodiment herein, the content management module 118 is configured to distribute the plurality of content posts through a social-networking content feed.

In one embodiment herein, the role-based provisioning module 120 is operatively coupled to the user-role management module 116 and the content management module 118. In one embodiment herein, the role-based provisioning module 120 is configured to determine, from the stored selected role, whether the user account comprises the mentor role. In one embodiment herein, responsive to determining that the user account comprises the mentor role, the role-based provisioning module 120 is configured to automatically generate an interactive booking control according to a platform-defined configuration.

In one embodiment herein, the role-based provisioning module 120 is configured to maintain booking-control association state logically associating the interactive booking control with the existing content posts and the subsequently generated content posts associated with the user account. In one embodiment herein, the booking-control association state is maintained without requiring user-authored creation, configuration, insertion, linking, tagging, placement, maintenance, booking-link creation, booking-service integration, booking-widget installation, or content-post modification.

In one embodiment herein, the role-based provisioning module 120 is configured to cause the interactive booking control to be presented with a content post among the existing content posts and the subsequently generated content posts by resolving the booking-control association state when the content post is served through the social-networking content feed. In one embodiment herein, responsive to modification of the selected role, the role-based provisioning module 120 is configured to automatically reconcile the booking-control association state such that the interactive booking control is added to or removed from the existing content posts and the subsequently generated content posts associated with the user account without requiring per-post manual modification of the content-post records.

In one embodiment herein, the booking-control association state comprises a logical association maintained separately from content of the content-post records. In one embodiment herein, the booking-control association state comprises metadata associated with the content-post records, wherein the metadata indicates association of the interactive booking control with the content posts without altering content of the content posts. In one embodiment herein, causing the interactive booking control to be presented comprises composing the interactive booking control into a served representation of the content post based on the booking-control association state. In one embodiment herein, the role-based provisioning module 120 is configured to automatically synchronize booking-control association status across previously stored content-post records and subsequently generated content-post records responsive to modification of the selected role.

In one embodiment herein, the interactive booking control is associated with individual content posts distributed through the social-networking content feed rather than solely with a profile interface associated with the user account. In one embodiment herein, the role-based provisioning module 120 is configured to remove association of the interactive booking control from the existing content posts and prevent association of the interactive booking control with subsequently generated content posts when the selected role no longer comprises the mentor role.

In one embodiment herein, activation of the interactive booking control causes presentation of availability information and pricing information associated with the user account within the social-networking platform without redirection to an external scheduling service. In one embodiment herein, the availability-management module 122 is configured to manage availability information comprising bookable session time slots. In one embodiment herein, the pricing-management module 124 is configured to manage pricing information associated with the bookable session time slots. In one embodiment herein, the availability information comprises recurring availability schedules, one-time availability schedules, or combinations thereof.

In one embodiment herein, the booking and scheduling module 126 is configured to receive a booking request corresponding to a selected session time slot, reserve the selected session time slot in a manner preventing conflicting booking requests corresponding to the selected session time slot, update the availability information responsive to reservation of the selected session time slot, propagate updated availability information to at least one client device 108 accessing the availability information, and generate a session record corresponding to the booking request. In one embodiment herein, the booking and scheduling module 126 is configured to update the availability information substantially immediately following reservation of the selected session time slot.

In one embodiment herein, the payment coordination module 128 is configured to receive payment authorization information associated with the booking request, coordinate payment authorization and payment confirmation for the selected session time slot through the payment-processing system 110 using a stored payment instrument associated with a viewer account, and generate booking-confirmation information responsive to successful payment confirmation. In one embodiment herein, the payment coordination module 128 is configured to generate payment-status information associated with the session record.

In one embodiment herein, the session-delivery module 130 is configured to generate session-access information associated with a scheduled mentorship session, communicate the session-access information to participant accounts through the social-networking platform, and establish and host the scheduled mentorship session through a platform-integrated communication interface without requiring an external video-conferencing service. In one embodiment herein, the session-delivery module 130 is configured to generate the session-access information at a predetermined time preceding the scheduled mentorship session. In one embodiment herein, the predetermined time comprises at least one hour before the scheduled mentorship session. In one embodiment herein, the session-delivery module 130 is configured to communicate the session-access information through in-application notifications.

In one embodiment herein, the state-management module 132 is configured to maintain synchronized state information among booking-control association information, availability information, booking information, payment information, scheduling information, and session information associated with the session record. In one embodiment herein, the state-management module 132 is configured to propagate state updates generated by the booking and scheduling module 126, the payment coordination module 128, and the session-delivery module 130 across the plurality of modules 114.

In one embodiment herein, the plurality of modules 114 is operatively coupled to automatically generate, associate, render, synchronize, update, and remove interactive booking controls across all existing content posts and all subsequently generated content posts responsive to changes in stored role information without requiring at least one of user-authored creation, configuration, insertion, linking, tagging, placement, maintenance, booking-link creation, booking-service integration, booking-widget installation, and content-post modification.

In one embodiment herein, the role-based provisioning module 120 maintains booking-control association state that governs presentation of the interactive booking control across content posts associated with the user account. In one embodiment herein, the booking-control association state comprises a logical association maintained separately from content of the content-post records. In another embodiment herein, the booking-control association state comprises metadata associated with the content-post records, wherein the metadata indicates association of the interactive booking control with the content posts without altering content of the content posts. In another embodiment herein, the interactive booking control is composed into a served representation of the content post based on the booking-control association state when the content post is served through the social-networking content feed.

In one embodiment herein, the booking-control association state comprises a single association record keyed to the user account and stored separately from the content-post records. In such embodiment, the interactive booking control is derived for a content post by resolving the single association record when the content post is served, thereby enabling presentation of the interactive booking control without performing a per-post write to the content-post records. In one embodiment herein, the booking-control association state is maintained in an association store or role-association index separate from the content-post records.

In one embodiment herein, responsive to modification of the selected role, the role-based provisioning module 120 reconciles the booking-control association state by an idempotent update operation. In one embodiment herein, the idempotent update operation causes repeated processing of the same role-modification event to produce a consistent booking-control association state. In one embodiment herein, the idempotent update operation comprises an atomic update operation. In another embodiment herein, the atomic update operation comprises a compare-and-set operation conditioned on version information associated with the booking-control association state.

In one embodiment herein, reconciliation of the booking-control association state is performed without rewriting each content-post record associated with the user account. Maintaining the booking-control association state separately from the content-post records reduces write operations associated with adding, removing, or updating the interactive booking control across existing content posts and subsequently generated content posts. In one embodiment herein, a storage cost and a write cost associated with reconciling the interactive booking control across content posts are reduced because the association is resolved from booking-control association state rather than separately written into each content-post record.

In one embodiment herein, the system 100 invalidates cached served representations associated with content posts of the user account responsive to reconciliation of the booking-control association state. In one embodiment herein, invalidating cached served representations causes subsequent content-serving requests to re-resolve the booking-control association state and present an updated interactive booking control state. In one embodiment herein, cache invalidation is performed across one or more cache nodes associated with serving the social-networking content feed, thereby maintaining cache consistency without requiring rewriting of the content-post records.

In one embodiment herein, the plurality of modules 114 is implemented as independently scalable services in a cloud-computing environment. In one embodiment herein, the booking-control association state, availability information, booking information, payment information, scheduling information, session information, and related state information are maintained in one or more shared data stores accessible to the plurality of modules 114. In one embodiment herein, content-serving operations and booking-control reconciliation operations are scaled independently to support distributed access by the client devices 108.

In one embodiment herein, modification of the selected role generates a role-change event. In one embodiment herein, the role-change event is published to an event bus, message broker, queue, or equivalent event-distribution mechanism. In one embodiment herein, one or more subscriber processes consume the role-change event and cause the role-based provisioning module 120 to reconcile the booking-control association state. In one embodiment herein, the reconciliation is performed asynchronously and idempotently such that duplicate or repeated delivery of the role-change event results in a consistent booking-control association state.

In one embodiment herein, reservation of the selected session time slot is performed using a concurrency-control mechanism. In one embodiment herein, each bookable session time slot is represented by a slot record having a slot-state field indicating at least one of an available state and a reserved state. In one embodiment herein, the booking and scheduling module 126 reserves the selected session time slot by executing an atomic compare-and-set operation on the slot-state field conditioned on the slot-state field indicating the available state, such that only one of a plurality of concurrent booking requests transitions the selected session time slot to the reserved state.

In one embodiment herein, the atomic reservation operation is performed within a database transaction enforcing a uniqueness constraint associated with the selected session time slot. In one embodiment herein, the uniqueness constraint prevents two reserved states for the same selected session time slot. In one embodiment herein, versioning, optimistic locking, transactional isolation, conditional writes, idempotency keys, or combinations thereof are used to maintain correctness under concurrent booking requests received from a plurality of client devices 108.

In one embodiment herein, the social-networking platform exposes one or more application-programming-interface endpoints through which operations associated with the interactive booking control are invoked. In one embodiment herein, activation of the interactive booking control invokes an application-programming-interface endpoint configured to return the availability information and the pricing information associated with the user account for presentation within the social-networking platform without redirection to an external scheduling service.

In one embodiment herein, the payment coordination module 128 communicates with the payment-processing system 110 through an application-programming-interface gateway of the social-networking platform. In one embodiment herein, the payment-processing system 110 communicates payment events to the social-networking platform through callbacks, webhook notifications, or equivalent event-notification mechanisms. In one embodiment herein, the session-delivery module 130 or the platform-integrated communication interface communicates session-related events through callbacks, webhook notifications, or equivalent event-notification mechanisms.

In one embodiment herein, the booking-control association state, availability information, payment information, booking information, scheduling information, and session information are synchronized across a plurality of distributed processing nodes serving the social-networking content feed. In one embodiment herein, the state-management module 132 propagates state updates across the plurality of modules 114 and the distributed processing nodes to maintain consistency of displayed booking controls, availability information, payment status, and session-access information.

In one embodiment herein, maintaining booking-control association state separately from content of the content-post records improves operation of the social-networking platform by reducing write amplification, improving synchronization efficiency, reducing stale or orphaned booking controls, supporting consistent rendering of the interactive booking control across existing and subsequently generated content posts, and enabling scalable content-serving operations in a distributed computing environment.

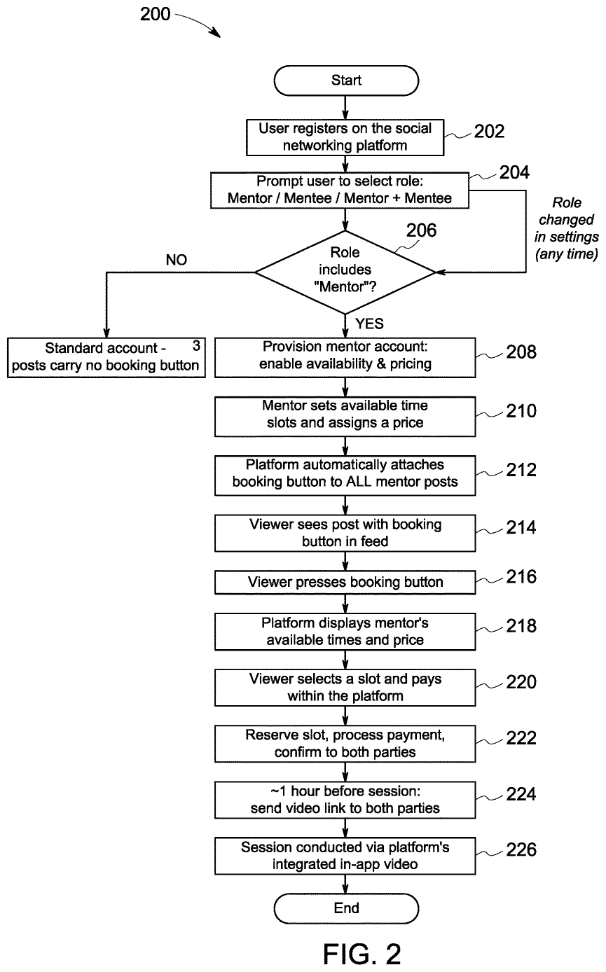

FIG. 2 refers to a flow diagram 200 of the system 100 depicting a method for role-based automatic association of interactive controls with content items on a social-networking platform. Referring to FIG. 2, the illustrated process demonstrates role-based provisioning of the mentorship-booking functionality, automatic attachment of the interactive booking control, session scheduling, payment processing, and platform-native session delivery within the social-networking platform.

At step 202, the user registers on the social-networking platform through the user account. Registration information associated with the user account is received and stored for subsequent account-provisioning operations. At step 204, the user-role management module 116 presents the role-selection interface configured to receive the role-selection information associated with the user account. The role-selection interface presents the mentor role, the mentee role, and the mentor-and-mentee role as selectable options. The selected role is stored in association with the user account and governs subsequent platform behavior associated with the user account for determining provisioning operations.

At step 206, the user-role management module 116 and the role-based provisioning module 120 determine whether the selected role comprises the mentor role. In certain embodiments, the selected role may be modified through account settings. Responsive to modification of the selected role, the role-based provisioning module 120 re-evaluates the selected role and repeats the provisioning operations associated with step 206. The re-evaluation process is performed each time the selected role is modified, thereby applying the provisioning logic repeatedly throughout the lifecycle of the user account rather than solely during registration.

When the selected role does not comprise the mentor role, the user account is maintained as the standard account and the content posts associated with the user account are distributed without the mentorship-booking functionality. Accordingly, the content posts associated with the user account do not contain the interactive booking control.

When the selected role comprises the mentor role, the process proceeds to step 208. At step 208, the role-based provisioning module 120 automatically provisions the mentorship-booking functionality associated with the user account. The provisioning operations include activation of the availability-management functionality, the pricing-management functionality, the booking functionality, the scheduling functionality, the payment functionality, and the session-delivery functionality associated with the mentor account.

At step 210, the availability-management module 122 receives the availability information associated with the mentor account. The availability information comprises the bookable session time slots corresponding to the mentorship sessions. The pricing-management module 124 receives the pricing information associated with the bookable session time slots and stores the pricing information for subsequent presentation during the booking operations.

At step 212, the role-based provisioning module 120 automatically generates the interactive booking control associated with the mentorship-booking functionality and automatically attaches the interactive booking control to all existing content posts and all subsequently generated content posts associated with the mentor account. The attachment of the interactive booking control is performed automatically by the platform without requiring manual creation, configuration, insertion, linking, tagging, placement, or maintenance by the mentor account. The interactive booking control remains associated with all content posts corresponding to the mentor account while the selected role comprises the mentor role.

At step 214, the viewer account accesses the social-networking content feed and views the content post associated with the mentor account. The content post is presented together with the interactive booking control rendered therein, thereby enabling direct access to the mentorship-booking functionality from the content post.

At step 216, the viewer account activates the interactive booking control through the client device 108. Activation of the interactive booking control initiates the booking operations associated with the mentor account. At step 218, the booking and scheduling module 126 retrieves the availability information and the pricing information associated with the mentor account. The booking and scheduling module 126 causes presentation of the availability information and the pricing information within the social-networking platform without redirecting the viewer account to an external scheduling service.

At step 220, the viewer account selects the session time slot from the presented availability information and authorizes the payment associated with the selected session time slot. The payment authorization information associated with the booking request is received through the social-networking platform. At step 222, the booking and scheduling module 126 reserves the selected session time slot in a manner preventing concurrent booking requests corresponding to the selected session time slot. The reserved session time slot is no longer available for booking by other accounts. The availability information is updated responsive to reservation of the selected session time slot, and the updated availability information is propagated to the client devices 108 accessing the availability information. The payment coordination module 128 coordinates the payment authorization and the payment confirmation through the payment-processing system 110 and generates the booking-confirmation information responsive to successful payment confirmation. The confirmation information associated with the scheduled mentorship session is communicated to both the mentor account and the viewer account.

At step 224, the session-delivery module 130 generates the session-access information associated with the scheduled mentorship session and communicates the session-access information to the participating accounts through the social-networking platform. In certain embodiments, the session-access information is generated and communicated approximately one hour prior to commencement of the scheduled mentorship session. At step 226, the session-delivery module 130 establishes and hosts the scheduled mentorship session through the platform-integrated communication interface. The mentor account and the viewer account participate in the mentorship session through the social-networking platform without requiring an external video-conferencing service.

Throughout the process illustrated in FIG. 2, the state-management module 132 maintains consistency among the availability information, the booking information, the payment information, the scheduling information, and the session information associated with the session record. The state-management module 132 further propagates the state updates generated by the booking and scheduling module 126, the payment coordination module 128, and the session-delivery module 130 across the plurality of modules 114 to maintain synchronized operational state information.

The process illustrated in FIG. 2 enables end-to-end mentorship discovery, booking, payment processing, scheduling, and session delivery within the unified social-networking platform environment. Automatic role-based provisioning of the mentorship-booking functionality and automatic attachment of the interactive booking control to all content posts associated with mentor accounts eliminates manual booking-control setup operations and associates the booking functionality directly with the content posts that generated viewer interest. Presentation of the availability information, the pricing information, the booking functionality, the payment processing functionality, the scheduling functionality, and the session-delivery functionality within the social-networking platform reduces reliance on external scheduling services, external payment services, and external video-conferencing services. Further, modification of the selected role causes re-execution of the provisioning operations, enabling a single user account to selectively operate as the mentor account, the mentee account, or the mentor-and-mentee account throughout the lifecycle of the user account.

The system 100 maintains operational consistency and synchronization among user-participation activities, availability information, transaction information, scheduling information, and session-related information within a common platform environment. The system 100 reduces manual configuration activities associated with making mentorship services available to users of a social networking platform. The system 100 improves consistency, accessibility, and availability of user-engagement mechanisms associated with mentorship-related interactions throughout a social networking environment.

The system 100 improves efficiency of appointment coordination and reduces scheduling conflicts arising from inconsistencies among independently maintained scheduling resources. The system 100 improves reliability, timeliness, and predictability of access to remotely conducted mentorship sessions. The system 100 minimizes administrative burden associated with establishing, managing, coordinating, and participating in mentorship engagements. The system 100 improves conversion of user interest generated through content engagement into completed mentorship transactions. The system 100 reduces abandonment of mentorship-related transactions resulting from transitions between multiple independent services. The system 100 lowers barriers to participation for users seeking to offer mentorship services through online platform environments.

The system 100 automatically provisions mentorship-booking functionality responsive to role information stored for a user account and automatically updates availability of the mentorship-booking functionality when the stored role information changes. The system 100 eliminates manual placement, modification, and removal of booking controls associated with mentorship services and maintains consistency of booking-control availability across existing content posts and subsequently generated content posts associated with the user account. The system 100 reduces occurrence of stale booking references, orphaned booking controls, and inconsistently configured booking interfaces by generating and maintaining the interactive booking controls through platform-managed provisioning operations derived from stored role information. The system 100 improves reliability and consistency of mentorship-access mechanisms presented throughout the social-networking platform. The system 100 improves reservation integrity by reserving selected session time slots in a manner preventing conflicting booking requests associated with the selected session time slots. The system 100 further propagates updated availability information responsive to reservation activities, thereby reducing double-booking conditions and improving accuracy of displayed scheduling information. In one embodiment herein, modification of stored role information automatically triggers platform-managed provisioning operations without requiring manual configuration of individual content posts.

The system 100 enables direct transition from content engagement to mentorship-session booking through interactive booking controls rendered within content-post interfaces, thereby reducing user-interaction friction between discovery and transaction activities and increasing conversion of user interest into completed mentorship bookings. The system 100 supports platform-generated revenue opportunities associated with mentorship transactions by facilitating platform-managed booking, payment processing, scheduling, and session-delivery activities. The system 100 enables application of transaction-related service fees associated with completed mentorship engagements. The system 100 supports flexible participation of users as mentors, mentees, or mentor-and-mentee users through role-selection and role-modification functionality. The system 100 facilitates mentorship interactions among users participating in multiple mentorship capacities and improves overall marketplace activity within the social-networking platform. In one embodiment herein, the interactive booking control is associated directly with individual content posts distributed through the social-networking content feed rather than solely with a profile interface associated with a user account, thereby enabling booking initiation at the point of content engagement.

The system 100 supports monetization of expertise through platform-managed mentorship interactions. The system 100 facilitates collection and retention of transaction-related, participation-related, and engagement-related information for operational management, analytics, trust, and service-improvement activities. The system 100 supports participation of users in multiple mentorship capacities within a common platform environment. The system 100 increases mentorship-related engagement, transaction activity, user participation, and platform retention within a social networking ecosystem.

In one embodiment herein, the mentorship functionality is associated with individual users, organizations, educational institutions, professional-service providers, consulting entities, coaching providers, training providers, subject-matter experts, or combinations thereof. The selected role associated with an account may correspond to a mentor role, a mentee role, a mentor-and-mentee role, a coach role, a consultant role, an instructor role, an advisor role, or other service-provider roles configured to provide scheduled interactions through the social-networking platform.

In one embodiment herein, the interactive booking control comprises a booking button, booking link, booking icon, booking banner, booking widget, booking card, booking panel, booking overlay, booking menu item, or combinations thereof. The interactive booking control may be rendered within content posts, profile pages, content feeds, comments, messaging interfaces, creator pages, recommendation interfaces, or other user-interface regions associated with the social-networking platform. In one embodiment herein, the content posts comprise text content, image content, video content, audio content, live-stream content, short-form content, long-form content, educational content, promotional content, social-networking content, professional-networking content, or combinations thereof. The interactive booking control may be automatically associated with any content type distributed through the social-networking platform.

In one embodiment herein, the availability information comprises recurring schedules, non-recurring schedules, calendar-based schedules, event-based schedules, recurring weekly schedules, recurring monthly schedules, custom schedules, blackout periods, unavailable periods, or combinations thereof. The availability information may be modified dynamically through user interactions, administrative controls, automated scheduling operations, or combinations thereof. In one embodiment herein, the pricing information comprises fixed pricing, variable pricing, tiered pricing, duration-based pricing, promotional pricing, subscription pricing, package pricing, discounted pricing, dynamic pricing, or combinations thereof. Different session types associated with a user account may be assigned different pricing information.

In one embodiment herein, the mentorship session comprises one-on-one sessions, group sessions, educational sessions, coaching sessions, advisory sessions, consulting sessions, interview-preparation sessions, career-guidance sessions, tutoring sessions, training sessions, workshop sessions, or combinations thereof. In one embodiment herein, the payment-processing system comprises payment gateways, payment processors, digital-wallet systems, banking systems, card-processing systems, mobile-payment systems, subscription-management systems, or combinations thereof. Payment authorization, payment capture, payment confirmation, refund processing, and transaction-verification operations may be performed through the payment-processing system.

In one embodiment herein, the session-access information comprises video-conferencing links, communication-session identifiers, meeting-access credentials, session tokens, secure-access credentials, notification messages, calendar invitations, reminder notifications, or combinations thereof. The session-access information may be communicated through in-application notifications, electronic mail messages, short-message services, push notifications, messaging services, or combinations thereof.

In one embodiment herein, the platform-integrated communication interface comprises video communication interfaces, audio communication interfaces, text-based communication interfaces, screen-sharing interfaces, collaborative-workspace interfaces, file-sharing interfaces, interactive-whiteboard interfaces, or combinations thereof. The mentorship session may be conducted through one or more communication modalities supported by the social-networking platform. In one embodiment herein, the role-based provisioning operations are performed responsive to account creation, account modification, administrative actions, role-selection activities, role-modification activities, account-verification activities, or combinations thereof. The role-based provisioning operations may be executed in real time, near real time, periodically, or responsive to predefined triggering events.

In one embodiment herein, the automatic attachment operations comprise generation, insertion, association, rendering, updating, synchronization, modification, removal, or combinations thereof of the interactive booking control relative to content posts associated with a user account. The automatic attachment operations may be performed without requiring manual modification of individual content posts. In one embodiment herein, the social-networking platform maintains synchronized operational information among the user-role management module, the content management module, the availability-management module, the pricing-management module, the booking and scheduling module, the payment coordination module, the session-delivery module, and the state-management module to support consistent execution of mentorship-booking activities across distributed computing environments.

In one embodiment herein, the social-networking platform is implemented as a web-based platform, a mobile platform, a cloud-computing platform, a distributed-computing platform, a software-as-a-service platform, or combinations thereof. The plurality of modules 114 may execute on one or more computing devices operating in centralized, distributed, clustered, virtualized, or cloud-based computing environments.

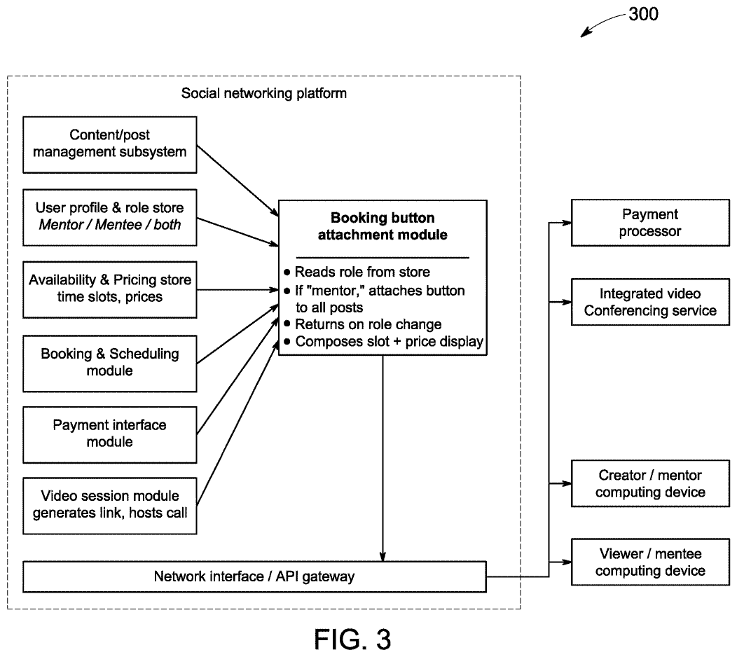

FIG. 3 refers to a block diagram 300 of a system architecture for role-based automatic association of interactive controls with content items within the social-networking platform. As illustrated, the role-based provisioning module 120 operates as a centralized booking-control attachment component configured to interact with the content management module 118, the user-role management module 116, the availability-management module 122, the booking and scheduling module 126, the payment coordination module 128, and the session-delivery module 130. The role-based provisioning module 120 receives role information associated with user accounts and determines whether a user account comprises the mentor role. The role-based provisioning module 120 functions as the booking-control attachment component illustrated in FIG. 3.

Responsive to determining that the selected role comprises the mentor role, the role-based provisioning module 120 automatically generates the interactive booking control and associates the interactive booking control with all existing content posts and all subsequently generated content posts corresponding to the mentor account. Responsive to modification of the selected role, the role-based provisioning module 120 re-executes role-evaluation operations and automatically updates attachment status of the interactive booking control across the content posts associated with the user account.

The role-based provisioning module 120 further accesses the availability information maintained by the availability-management module 122 and the pricing information associated with the bookable session time slots. The role-based provisioning module 120 composes presentation information comprising available session time slots and corresponding pricing information retrieved from the availability information and pricing information associated with the mentor account.

Upon activation of the interactive booking control by a viewer account, the role-based provisioning module 120 causes presentation of the available session time slots and associated pricing information within the social-networking platform. As further illustrated, the booking and scheduling module 126 manages booking requests corresponding to selected session time slots and generates session records associated with scheduled mentorship sessions. The payment coordination module 128 communicates with the payment-processing system 110 to coordinate payment authorization and payment confirmation operations corresponding to booking requests.

The session-delivery module 130 generates session-access information associated with scheduled mentorship sessions and facilitates participation in mentorship sessions through the platform-integrated communication interface. The session-access information is communicated to participant accounts through the social-networking platform prior to commencement of the scheduled mentorship session. The network interface associated with the social-networking platform facilitates communication among the creator or mentor computing device, the viewer or mentee computing device, the payment-processing system 110, and the platform-integrated communication interface. Accordingly, the architecture illustrated in FIG. 3 enables automatic role-based generation, attachment, updating, and removal of the interactive booking control while supporting integrated availability presentation, booking operations, payment processing, scheduling operations, and platform-native session delivery within a unified social-networking environment. As illustrated in FIG. 3, the network interface or API gateway facilitates exchange of booking information, payment information, session-access information, and communication data between internal platform components and external entities, including the payment-processing system 110, the creator or mentor computing device, and the viewer or mentee computing device.

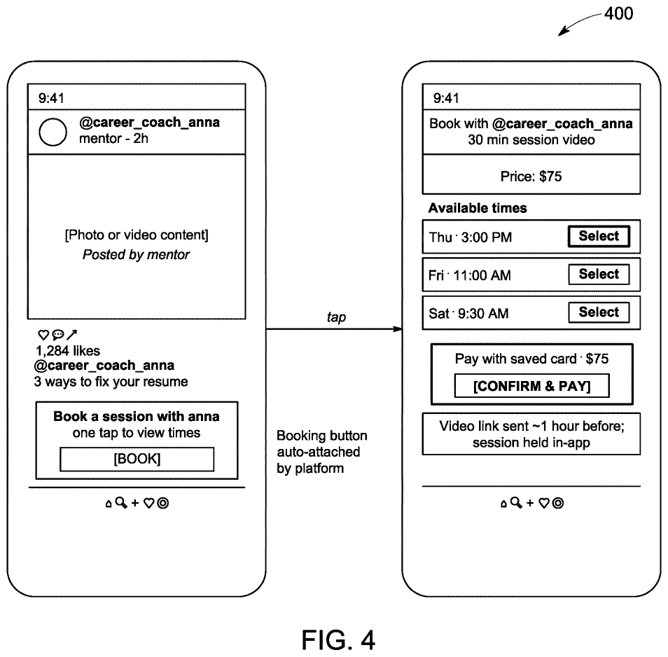

FIG. 4 refers to an exemplary user-interface workflow 400 for role-based automatic association of interactive controls with content items within the social-networking platform. The FIG. 4 illustrates a first user-interface screen displayed on a viewer computing device and a second user-interface screen displayed responsive to activation of an interactive booking control. The workflow demonstrates presentation of mentor-generated content, automatic attachment of the interactive booking control by the social-networking platform, retrieval of availability information and pricing information, session reservation, payment authorization, and delivery of session-related information within the social-networking platform.

As illustrated in the first screen, the viewer computing device displays a content post distributed through the social-networking content feed. The content post comprises a mentor identifier associated with a mentor account and content information comprising photographic content, video content, or combinations thereof published by the mentor account. The content post further comprises an interactive booking control rendered within a content-post interface associated with the mentor account. The interactive booking control is automatically generated and attached by the social-networking platform responsive to the selected role associated with the mentor account comprising the mentor role. The interactive booking control is not manually created, configured, inserted, linked, tagged, positioned, or maintained by the mentor account and is automatically rendered across all existing content posts and all subsequently generated content posts associated with the mentor account while the selected role comprises the mentor role.

Activation of the interactive booking control by a viewer account causes retrieval of availability information and pricing information associated with the mentor account and initiates presentation of booking-related information within the social-networking platform without redirection to an external scheduling service. A single user interaction with the interactive booking control causes generation of a booking interface displayed on the viewer computing device. As illustrated in the second screen, the booking interface comprises a session header configured to identify the mentor account and a corresponding mentorship-session type. The booking interface further comprises pricing information corresponding to the mentorship session. The pricing information corresponds to pricing information previously defined and stored by the mentor account through the pricing-management functionality of the social-networking platform.

The booking interface further comprises a plurality of available session time slots associated with the mentor account. The available session time slots are retrieved from availability information maintained by the social-networking platform and correspond to bookable session time slots previously specified by the mentor account. The available session time slots are presented within the social-networking platform together with the pricing information, thereby enabling selection of a desired mentorship-session time slot without requiring navigation to an external scheduling environment.

Upon selection of a desired session time slot from the available session time slots, the viewer account initiates reservation of the selected session time slot through a payment confirmation control. The payment confirmation control enables confirmation of the selected session time slot and authorization of payment using a stored payment instrument associated with the viewer account. Responsive to successful payment authorization and payment confirmation, the social-networking platform reserves the selected session time slot, prevents conflicting reservations associated with the selected session time slot, updates corresponding availability information, and generates booking-confirmation information associated with the scheduled mentorship session.

The booking interface further comprises a session notification region configured to communicate session-delivery information associated with the scheduled mentorship session. The session notification region indicates that session-access information that comprises a video-conferencing link will be generated and communicated to participant accounts approximately one hour before commencement of the scheduled mentorship session. The session notification region further indicates that the mentorship session will be established and conducted through the platform-integrated communication interface of the social-networking platform without requiring an external video-conferencing service.

The illustrated user-interface workflow therefore demonstrates integration of mentor-generated content, automatically attached interactive booking controls, mentor-defined availability information, mentor-defined pricing information, session reservation, payment authorization, booking confirmation, session-access information, and platform-native session delivery within the social-networking platform, thereby enabling mentorship discovery, booking, scheduling, payment processing, and mentorship-session participation through a unified platform environment.

The system 100 facilitates mentorship-related interactions within a social networking platform environment. The system 100 enables efficient transition from content engagement to mentorship-related transactions within a common platform environment. The system 100 reduces reliance on multiple independent systems, service providers, and computing environments for completing mentorship-related activities. The system 100 reduces workflow fragmentation, network transitions, data handoffs, and operational complexity associated with scheduling, payment, and session-participation activities.

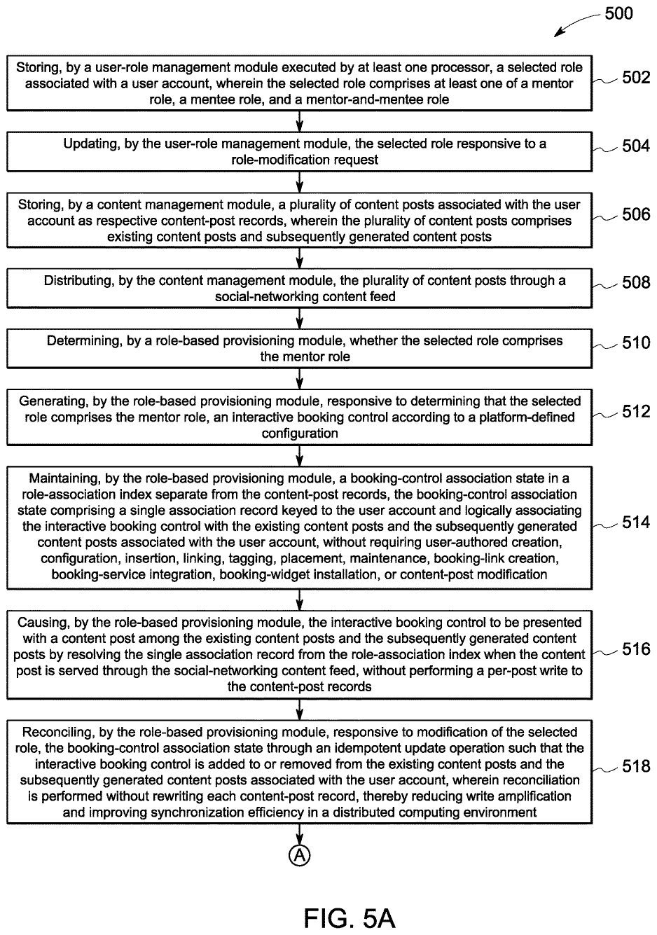

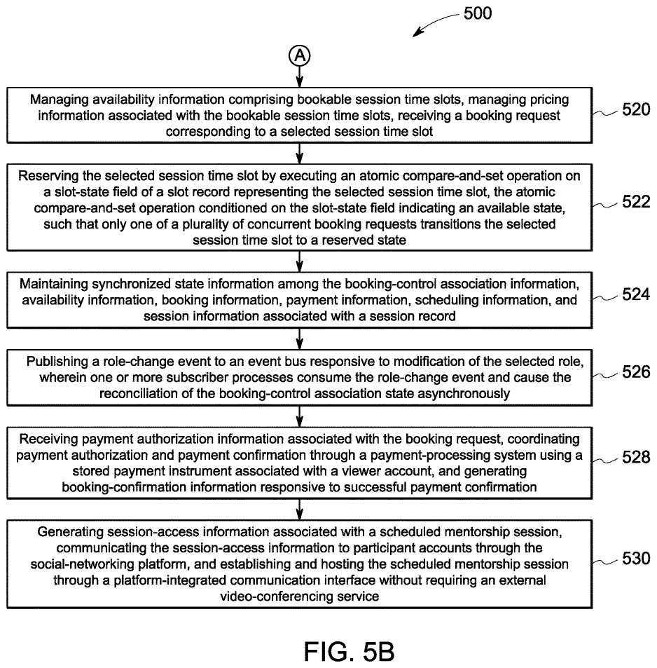

FIGS. 5A-5B refer to a flowchart 500 of a method for role-based automatic booking control attachment and platform-native session delivery on the social networking platform through the system 100. At step 502, the user-role management module 116 stores the selected role associated with the user account. In one embodiment herein, the selected role comprises at least one of the mentor role, the mentee role, and the mentor-and-mentee role. At step 504, the user-role management module 116 updates the selected role responsive to the role-modification request.

At step 506, the content management module 118 stores the plurality of content posts associated with the user account as respective content-post records. In one embodiment herein, the plurality of content posts comprises the existing content posts and the subsequently generated content posts. At step 508, the content management module 118 distributes the plurality of content posts through the social-networking content feed. At step 510, the role-based provisioning module 120 determines whether the selected role comprises the mentor role. At step 512, responsive to determining that the selected role comprises the mentor role, the role-based provisioning module 120 generates the interactive booking control according to the platform-defined configuration.

At step 514, the role-based provisioning module 120 maintains the booking-control association state logically associating the interactive booking control with the existing content posts and the subsequently generated content posts associated with the user account. In one embodiment herein, the booking-control association state is maintained without requiring user-authored creation, configuration, insertion, linking, tagging, placement, maintenance, booking-link creation, booking-service integration, booking-widget installation, or content-post modification. At step 516, the role-based provisioning module 120 causes the interactive booking control to be presented with the content post among the existing content posts and the subsequently generated content posts by resolving the booking-control association state when the content post is served through the social-networking content feed. At step 518, responsive to modification of the selected role, the role-based provisioning module 120 reconciles the booking-control association state such that the interactive booking control is added to or removed from the existing content posts and the subsequently generated content posts associated with the user account without requiring per-post manual modification of the content-post records.

At step 520, responsive to activation of the interactive booking control, the system 100 presents availability information and pricing information associated with the user account within the social-networking platform without redirection to an external scheduling service. At step 522, the booking and scheduling module 126 receives the booking request corresponding to the selected session time slot and reserves the selected session time slot in a manner preventing conflicting booking requests corresponding to the selected session time slot. At step 524, the booking and scheduling module 126 updates the availability information responsive to reservation of the selected session time slot, propagates updated availability information to at least one client device 108 accessing the availability information, and generates the session record corresponding to the booking request.

At step 526, the payment coordination module 128 receives payment authorization information associated with the booking request, coordinates payment authorization and payment confirmation through the payment-processing system 110 using the stored payment instrument associated with the viewer account, and generates booking-confirmation information responsive to successful payment confirmation. At step 528, the session-delivery module 130 generates session-access information associated with the scheduled mentorship session, communicates the session-access information to participant accounts through the social-networking platform, and establishes and hosts the scheduled mentorship session through the platform-integrated communication interface without requiring an external video-conferencing service. Further, at step 530, the state-management module 132 maintains synchronized state information among booking-control association information, availability information, booking information, payment information, scheduling information, and session information associated with the session record.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principles of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

It will readily be apparent that numerous modifications and alterations can be made to the process described in the foregoing examples without departing from the principles underlying the invention, and all such modifications and alterations are intended to be embraced by this application.

The claimed invention is:

1. A system for role-based automatic association of interactive controls with content items on a social-networking platform, comprising:
a computing device having at least one processor and at least one memory storing executable instructions,
wherein the computing device is operatively connected to at least one client device and at least one payment-processing system via at least one network, and
wherein the at least one processor is configured to execute a plurality of modules to cause the system to:
store a selected role associated with a user account by a user-role management module, wherein the selected role comprises at least one of a mentor role, a mentee role, and a mentor-and-mentee role, and update the selected role responsive to a role-modification request;
store, as respective content-post records by a content management module, a plurality of content posts associated with the user account and distribute the plurality of content posts through a social-networking content feed, wherein the plurality of content posts comprises existing content posts and subsequently generated content posts;
a role-based provisioning module, operatively coupled to the user-role management module and the content management module, wherein the role-based provisioning module is configured to:
determine, from the stored selected role, whether the user account comprises the mentor role;
responsive to determining that the user account comprises the mentor role, automatically generate an interactive booking control according to a platform-defined configuration;
maintain a booking-control association state in a role-association index separate from the content-post records, the booking-control association state comprising a single association record keyed to the user account and logically associating the interactive booking control with the existing content posts and the subsequently generated content posts associated with the user account, without requiring user-authored creation, configuration, insertion, linking, tagging, placement, maintenance, booking-link creation, booking-service integration, booking-widget installation, or content-post modification;
cause the interactive booking control to be presented with a content post among the existing content posts and the subsequently generated content posts by resolving the single association record from the role-association index when the content post is served through the social-networking content feed, without performing a per-post write to the content-post records; and
responsive to modification of the selected role, automatically reconcile the booking-control association state through an idempotent update operation such that the interactive booking control is added to or removed from the existing content posts and the subsequently generated content posts associated with the user account, wherein reconciliation is performed without rewriting each content-post record, thereby reducing write amplification and improving synchronization efficiency in a distributed computing environment.

2. The system of claim 1, further comprising:
an availability-management module configured to manage availability information comprising bookable session time slots;
a pricing-management module configured to manage pricing information associated with the bookable session time slots;
a booking and scheduling module configured to receive a booking request corresponding to a selected session time slot,
wherein each bookable session time slot is represented by a slot record having a slot-state field indicating at least one of an available state and a reserved state, and
wherein the booking and scheduling module is configured to reserve the selected session time slot by executing an atomic compare-and-set operation on the slot-state field conditioned on the slot-state field indicating the available state, such that only one of a plurality of concurrent booking requests transitions the selected session time slot to the reserved state.

3. The system of claim 1, further comprising:
a state-management module configured to maintain synchronized state information among the booking-control association information, availability information, booking information, payment information, scheduling information, and session information associated with a session record, and
wherein modification of the selected role generates a role-change event published to an event bus, and wherein one or more subscriber processes consume the role-change event and cause the role-based provisioning module to reconcile the booking-control association state asynchronously.

4. The system of claim 1, wherein the role-based provisioning module is configured to reconcile the booking-control association state via an atomic update operation conditioned on version information associated with the booking-control association state.

5. The system of claim 1, wherein the system is configured to invalidate cached served representations associated with content posts of the user account responsive to reconciliation of the booking-control association state, thereby causing subsequent content-serving requests to re-resolve the booking-control association state and present an updated interactive booking control state.

6. The system of claim 1, wherein the interactive booking control is associated with individual content posts distributed through the social-networking content feed rather than solely with a profile interface associated with the user account.

7. The system of claim 1, wherein the role-based provisioning module is configured to remove association of the interactive booking control from the existing content posts and prevent association of the interactive booking control with subsequently generated content posts when the selected role no longer comprises the mentor role.

8. The system of claim 1, wherein activation of the interactive booking control invokes an application-programming-interface endpoint configured to return availability information and pricing information associated with the user account for presentation within the social-networking platform without redirection to an external scheduling service.

9. The system of claim 1, wherein the plurality of modules is operatively coupled to automatically generate, associate, render, synchronize, update, and remove interactive booking controls across all existing content posts and all subsequently generated content posts responsive to changes in stored role information without requiring at least one of user-authored creation, configuration, insertion, linking, tagging, placement, maintenance, booking-link creation, booking-service integration, booking-widget installation, and content-post modification.

10. The system of claim 2, wherein the booking and scheduling module is further configured to:
update the availability information responsive to reservation of the selected session time slot;
propagate updated availability information to at least one client device accessing the availability information; and
generate a session record corresponding to the booking request.

11. The system of claim 2, further comprising a payment coordination module configured to receive payment authorization information associated with the booking request, coordinate payment authorization and payment confirmation for the selected session time slot through a payment-processing system using a stored payment instrument associated with a viewer account, and generate booking-confirmation information responsive to successful payment confirmation.

12. The system of claim 2, further comprising a session-delivery module configured to generate session-access information associated with a scheduled mentorship session, communicate the session-access information to participant accounts through the social-networking platform, and establish and host the scheduled mentorship session through a platform-integrated communication interface without requiring an external video-conferencing service.

13. The system of claim 3, wherein the state-management module is configured to propagate state updates generated by the booking and scheduling module, the payment coordination module, and the session-delivery module across the plurality of modules.

14. A method for role-based automatic association of interactive controls with content items on a social-networking platform through a system, comprising:
storing, by a user-role management module executed by at least one processor, a selected role associated with a user account, wherein the selected role comprises at least one of a mentor role, a mentee role, and a mentor-and-mentee role;
updating, by the user-role management module, the selected role responsive to a role-modification request;
storing, by a content management module, a plurality of content posts associated with the user account as respective content-post records, wherein the plurality of content posts comprises existing content posts and subsequently generated content posts;
distributing, by the content management module, the plurality of content posts through a social-networking content feed;
determining, by a role-based provisioning module, whether the selected role comprises the mentor role;
generating, by the role-based provisioning module, responsive to determining that the selected role comprises the mentor role, an interactive booking control according to a platform-defined configuration;
maintaining, by the role-based provisioning module, a booking-control association state in a role-association index separate from the content-post records, the booking-control association state comprising a single association record keyed to the user account and logically associating the interactive booking control with the existing content posts and the subsequently generated content posts associated with the user account, without requiring user-authored creation, configuration, insertion, linking, tagging, placement, maintenance, booking-link creation, booking-service integration, booking-widget installation, or content-post modification;
causing, by the role-based provisioning module, the interactive booking control to be presented with a content post among the existing content posts and the subsequently generated content posts by resolving the single association record from the role-association index when the content post is served through the social-networking content feed, without performing a per-post write to the content-post records; and
reconciling, by the role-based provisioning module, responsive to modification of the selected role, the booking-control association state through an idempotent update operation such that the interactive booking control is added to or removed from the existing content posts and the subsequently generated content posts associated with the user account, wherein reconciliation is performed without rewriting each content-post record, thereby reducing write amplification and improving synchronization efficiency in a distributed computing environment.

15. The method of claim 14, further comprising:
managing availability information comprising bookable session time slots, managing pricing information associated with the bookable session time slots, receiving a booking request corresponding to a selected session time slot; and
reserving the selected session time slot by executing an atomic compare-and-set operation on a slot-state field of a slot record representing the selected session time slot, the atomic compare-and-set operation conditioned on the slot-state field indicating an available state, such that only one of a plurality of concurrent booking requests transitions the selected session time slot to a reserved state.

16. The method of claim 14, further comprising:
maintaining synchronized state information among the booking-control association information, availability information, booking information, payment information, scheduling information, and session information associated with a session record; and
publishing a role-change event to an event bus responsive to modification of the selected role, wherein one or more subscriber processes consume the role-change event and cause the reconciliation of the booking-control association state asynchronously.

17. The method of claim 14, further comprising:
receiving payment authorization information associated with the booking request, coordinating payment authorization and payment confirmation through a payment-processing system using a stored payment instrument associated with a viewer account, and generating booking-confirmation information responsive to successful payment confirmation.

18. The method of claim 14, further comprising:
generating session-access information associated with a scheduled mentorship session, communicating the session-access information to participant accounts through the social-networking platform, and establishing and hosting the scheduled mentorship session through a platform-integrated communication interface without requiring an external video-conferencing service.
